(19) United States
(12) Patent Application Publication
(10) Pub. No.: US 2012/0293666 A1
(43) Pub. Date: Nov. 22, 2012

(54) MULTI-DIRECTION SFR MEASUREMENT SYSTEM

(75) Inventors: We Rout Ai Wong, Pendang Kedah (MY); Angelyn Geetha, Penang (MY); Prebesh Pavithran, Bukit Mertajam (MY)

(73) Assignee: FLEXTRONICS AP, LLC, Broomfield, CO (US)

(21) Appl. No.: 13/476,420

(22) Filed: May 21, 2012

Related U.S. Application Data
(60) Provisional application No. 61/487,895, filed on May 19, 2011.

(51) Int. Cl. H04N 17/00

(52) U.S. Cl. 348/180; 348/E17.001

(57) ABSTRACT

A multi-directional SFR measurement system includes a rotatable test fixture located within an enclosure. Mounted on the test fixture is a test key for holding a camera module under test, a collimating lens, and a target/light source panel that provides a visible target for imaging by the camera module. A controller box located outside of the enclosure allows an operator to command the system to rotate the test fixture to a desired angle and capture an image of the target with the camera module under test. The system also includes an angle indicator to indicate the rotational angle of the test fixture and an air pressure controller/indicator to control and indicate the air pressure of the system used for positioning the collimating lens relative to the test fixture.

CROSS REFERENCE

This application is the non-provisional of U.S. Provisional Pat. Appl. No. 61/487,895 filed May 19, 2011, entitled “MULTI-DIRECTION SFR MEASUREMENT SYSTEM,” which is hereby incorporated by reference into this application.

### BACKGROUND

The disclosure herein relates generally to electronic devices, and more particularly to camera modules performance measuring systems.

In developing and manufacturing digital cameras, it can be desirable to measure the performance of digital cameras and/or components thereof. For example, there are systems and devices for measuring the image quality of camera modules. Current measurement systems, however, are substantially limited in that the performance measurements are acquired only for a single orientation of the camera module and, therefore, do not take in to consideration that the image quality may vary at different physical orientations of the camera module. For example, tiny debris within a camera module may be more detrimental to image quality at certain orientations than it is at other orientations. Therefore, acquiring measurements for only a single orientation is a poor representation of reality because the orientation of a camera module can vary substantially during normal use.

What is needed, therefore, is a camera module design that effectively measures the performance of digital cameras and/or camera components at various orientations.

### SUMMARY

The disclosed system overcomes the problems associated with the prior art by providing a multi-directional spatial frequency response (SFR) measurement system that can rotate a camera to any orientation/direction such that image quality can be quantified accurately. Based on motor movement in the multi-directional SFR measurement system, a camera can be held at any direction and image sharpness can be acquired accordingly. Note that the invention can be used for testing and qualification of any camera.

Disclosed herein is a system for testing a camera module under test, including: a test stand; a rotatable test fixture rotatably attached to the test stand, the test fixture accepting a camera module under test; and a target to be imaged by the camera module under test, the target being interconnected to the test fixture.

The system may further include a collimating lens interconnected to the test fixture, the collimating lens receiving light from the target and refracting the light toward the camera module under test. The system may be operated by a user, wherein the position of the collimating lens relative to the test fixture is controlled by air pressure, and further including an air pressure controller interconnected to the test fixture and fluidly connected to the interconnection of the collimating lens to the test fixture. The air pressure controller may include a fluid control actuator for the user to actuate to vary the air pressure. The air pressure controller may include an air pressure gauge to provide an indication to the user of the air pressure.

The camera module under test may be attached to a test jig which is attached to the test fixture, and wherein the collimating lens is also attached to the test jig. The collimating lens may further include a stopper of a predetermined length that is used to provide a predetermined spacing between the lens and the camera module under test. The system may include a controller associated therewith for controlling operation of the camera module under test. The controller may also control an angle of rotation of the rotatable test fixture.

The target may include at least one resolvable object in a center portion thereof and at least one resolvable object in a peripheral region thereof. The target may be in the shape of a rectangle and the at least one resolvable object in the peripheral region include at least four resolvable objects, one in each of four corners of the rectangle.

The target may be interconnected to the test fixture in a manner that allows for the distance between the target and the test fixture to be adjusted. The target may be directly attached to a light source panel that provides backlighting to the target. The frame may be in the shape of a box with lateral sidewalls and all of the lateral sidewalls include glass between members of the frame, so as to enclose the lateral sidewalls. The system may be operated by a user, and further including an angle indicator interconnected to the test fixture in a manner to maintain the same angular relationship between the angle indicator and the test fixture in order to provide an indication to the user of the angular position of the test fixture.

Also disclosed is a method for testing a camera module under test, including: affixing the camera module under test to a rotatable test fixture; rotating the test fixture to a desired angle; and capturing an image of a target with the camera module under test, the target being interconnected to the test fixture.

The method may further include image processing the captured image to determine the spatial frequency response of the camera module under test. The image processing may include determining the spatial frequency response at various points in the captured image. The rotating and capturing operations may be repeated for a plurality of angles. The method may further include providing a collimating lens interconnected to the test fixture, the lens being located between the target and the camera module under test.

### BRIEF DESCRIPTION OF THE DRAWINGS

The disclosure herein is described with reference to the following drawings, wherein like reference numbers denote substantially similar elements:

FIG. 1 is a picture of a multi-direction SFR measurement system that includes a multi-direction SFR measurement tester 100.

FIG. 2 is an image showing various components of tester 100.

FIG. 3 is an image showing an air pressure controller 208 and a pressure indicator 210 of tester 100.

FIG. 4 is an image showing an SFR target 400 positioned on a light source panel 212 of tester 100.

FIG. 5 is an image showing distance controller 214, light source panel 212, and collimator lens 206.

FIG. 6 is an image showing a controller box 600 and an inverter 602 of tester 100.

FIG. 7 is an image showing various details of angle control box 600 of tester 100.

FIG. 8 is an image showing angle indicator 216 fixably mounted on rotating fixture 200 of tester 100.

FIG. 9 is an image showing a camera module test key 900 fixably mounted to a test key holder jig 204.

FIG. 10 is another image showing camera module test key 900 fixably mounted to test key holder jig 204 of tester 100.

FIG. 11 is an image showing test results displayed on the screen of the computer system coupled to SFR measurement tester 100.

FIG. 12 shows a flowchart summarizing a process for operating tester 100.

FIG. 13 is an illustration of the various components of the tester 100.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

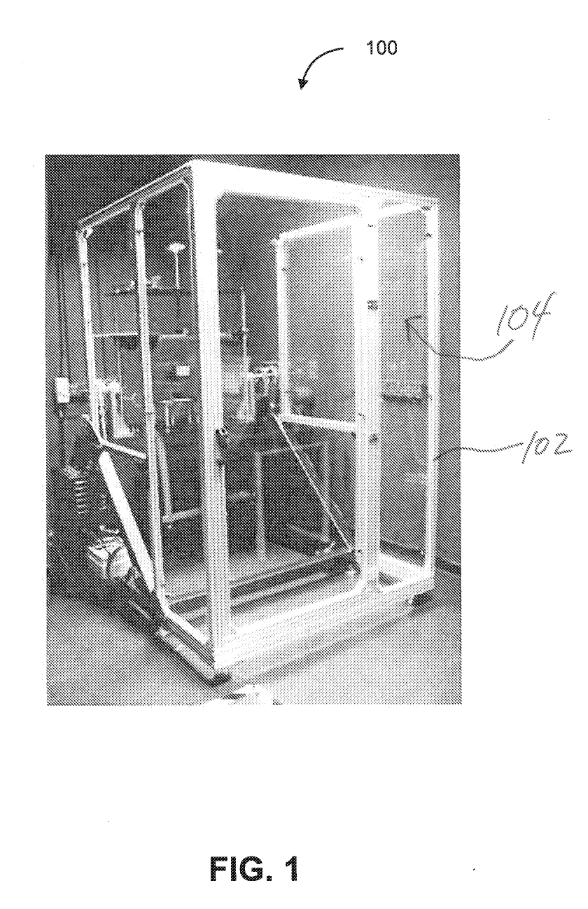

FIG. 1 is an image showing a multi-direction SFR measurement system for testing camera modules. The system includes a multi-direction SFR measurement tester 100 coupled to a computer system. During testing operations, tester 100 acquires test data and sends the data to the computer system for data processing. The tester 100 includes a metal frame 102 and glass windows 104 that encloses the moving parts of the tester for operator safety. Portions of the metal frame 102 may be considered as a test stand.

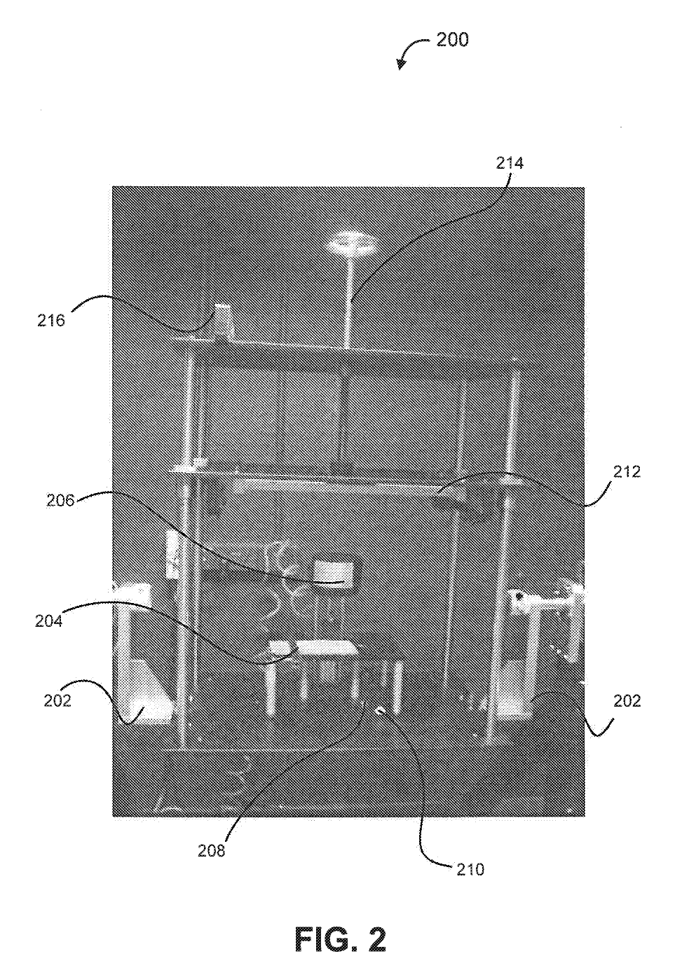

FIG. 2 is an image showing various components of tester 100 including a rotating fixture 200 fixably mounted to a set of rotating mechanical arms 202. The rotating fixture 200 includes a test key holder jig 204, an IsMedia collimator lens 206, an air pressure controller 208, an air pressure indicator 210, an IsMedia light source panel 212, a distance controller 214, and an angle indicator 216 fixably mounted thereon. Test key holder jig 204 provides a means for fixably mounting camera module test keys to rotating fixture 200. As can be appreciated, the fixture 200 can be rotated by the rotating mechanical arms 202 through an entire 360 degrees. The collimator lens 206 is a different lens than the lens (not shown) in the camera module. The collimator lens 206 is used to make objects (such as a target described in further detail below) appear as if much further away. With such a lens 206, the target can actually be at distances from the lens 206 in the range of 13.7 to 32.4 centimeters and appear to be at distances in the range of 40 centimeters to infinity. Of course, any other suitable lens could be used.

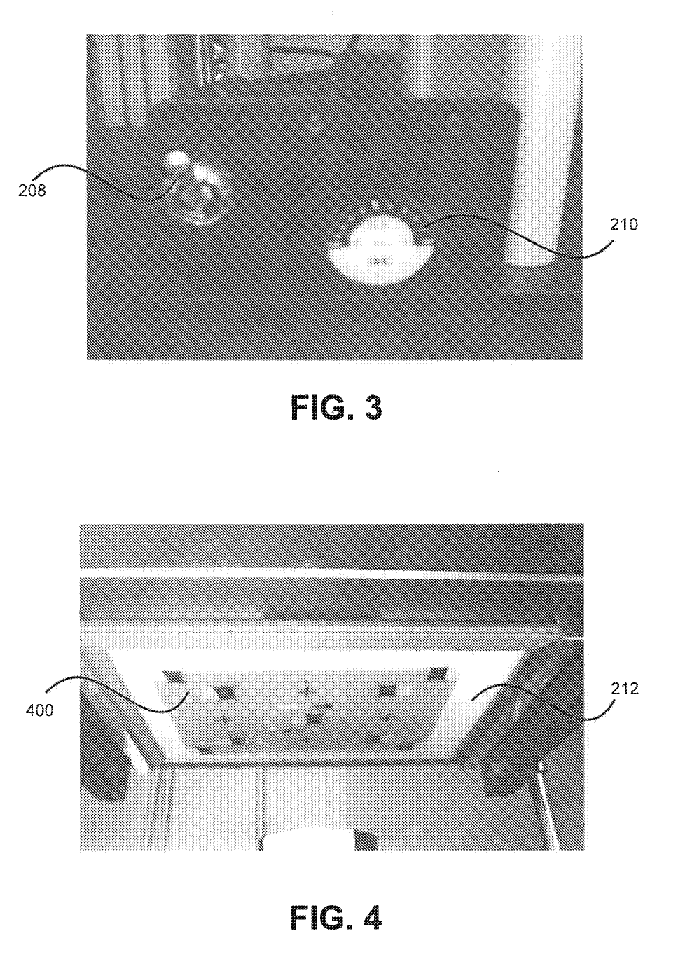

FIG. 3 is an image showing air pressure controller 208 and pressure indicator 210. Air pressure controller 208 provides an actuation means for adjusting the position of collimator lens 206 with respect to test key holder jig 204 via air pressure. Pressure indicator 210 facilitates the monitoring of the air pressure. While this adjustment is made with air pressure, it would also be possible for the position of collimator lens 206 to be adjusted in any other suitable fashion such as mechanically or electro-mechanically.

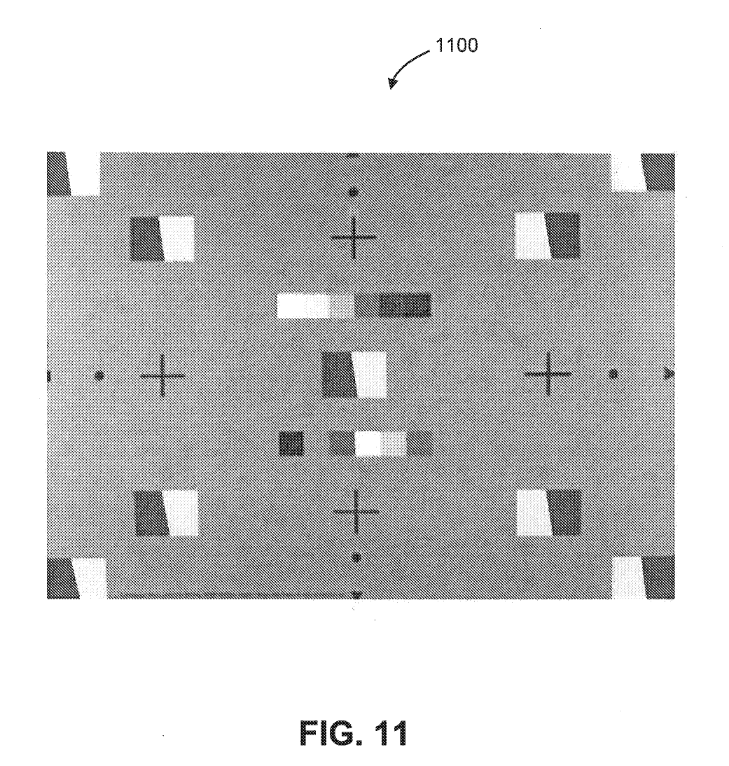

FIG. 4 is an image showing an SFR target 400 (shown in more detail in FIG. 11) positioned on light source panel 212. The light source panel 212 provides backlighting through the target 400 so that the camera module can image the target 400.

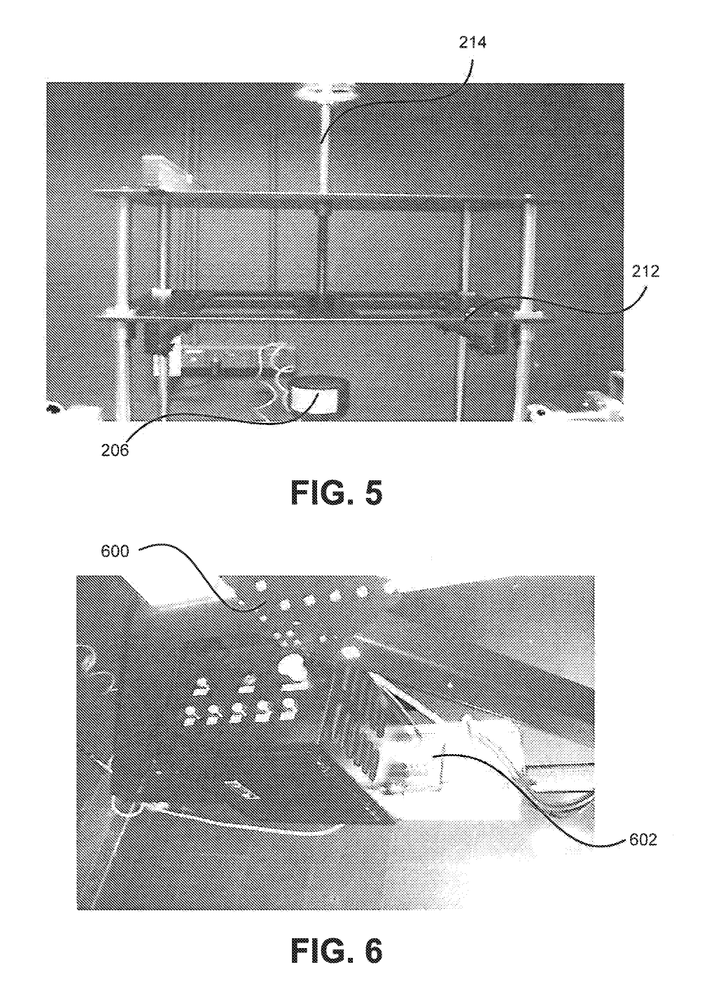

FIG. 5 is an image showing distance controller 214, light source panel 212, and collimator lens 206. Distance controller 214 provides a means for adjusting the linear displacement of light source panel 212 with respect to collimator lens 206. The distance controller 214 moves the light source panel 212 vertically along four guide rails.

FIG. 6 is an image showing a controller box 600 and an inverter 602 of tester 100. These components may be located outside of the metal frame 102 of the tester 100, particularly the controller box 600, so that the operator can control the operation of the tester 100. Controller box 600 provides a means for controlling the rotation of mechanical arms 202 and, therefore, the angular position of rotating fixture 200.

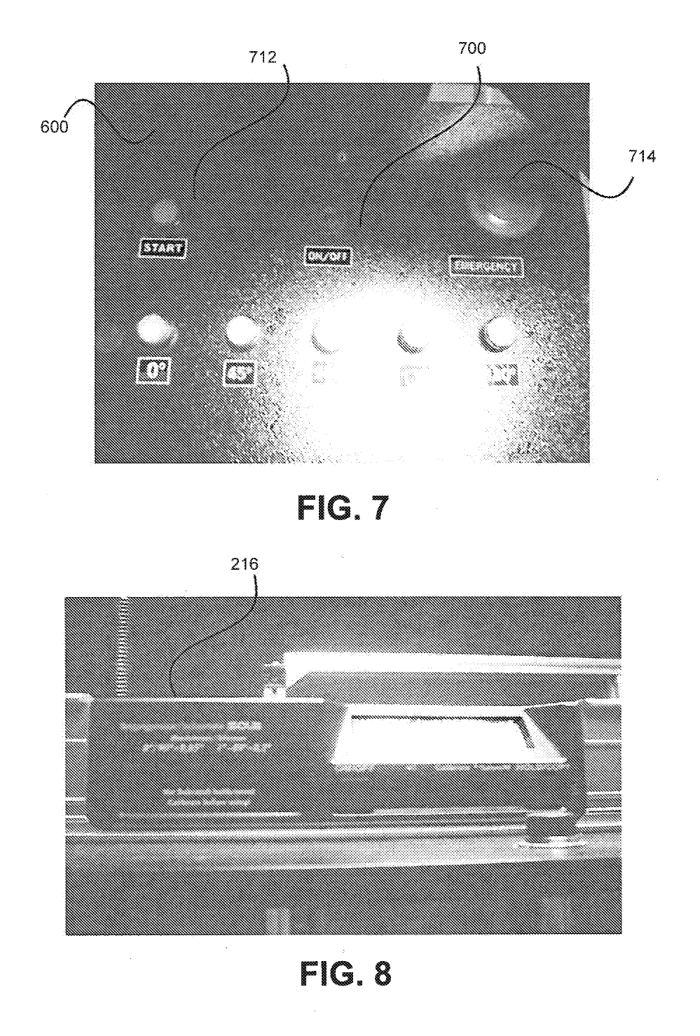

FIG. 7 is an image showing various details of controller box 600 including an on/off switch 700, a first button 702, a second button 704, a third button 706, a fourth button 708, a fifth button 710, a start button 712, and an emergency shutoff switch 714. The on/off switch 700 activates and deactivates the tester 100. Buttons 702, 704, 706, 708, and 710 provide a means for positioning rotating fixture 200 at 0, 45, 90, 135, and 180 degrees of rotation, respectively. The start button 712 is used by the operator to perform an SFR measurement after the operator has rotated the fixture 200 to the desired angle. As can be appreciated, the emergency shutoff switch 714 can be used for immediate shut down, in case of emergency.

FIG. 8 is an image showing angle indicator 216 fixably mounted on rotating fixture 200. Accordingly, angle indicator senses and displays the angle of rotating fixture 200. Any suitable angle indicator could be used. In this case, an angle indicator 216 with a digital display is provided.

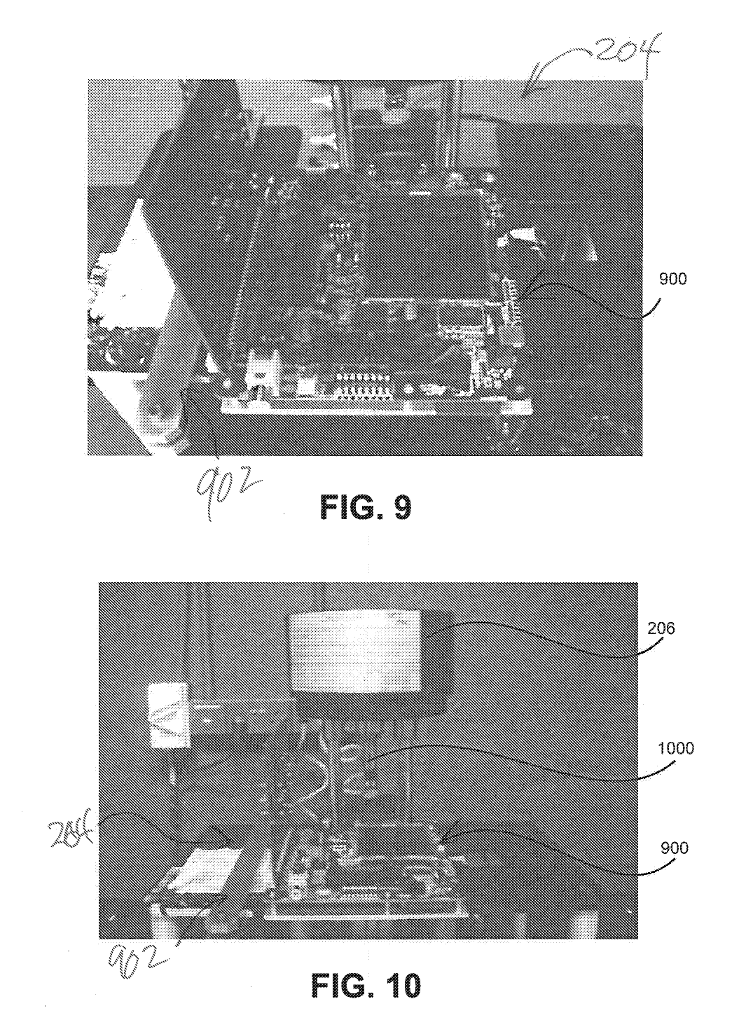

FIG. 9 is an image showing test key holder jig 204 with a camera module test key 900 fixably mounted thereto via a fixture 902 of holder jig 204. The test key 900 holds the camera module in place. The test key 900 may be specific to a particular model of camera module. It includes control electronics corresponding to that particular camera module. It is possible that the test key and fixture could be arranged so as to allow the camera module to be mounted thereto at different angular orientations.

FIG. 10 is another image showing camera module test key 900 fixably mounted to test key holder jig 204. Also shown is the attachment of the collimator lens 206 to the test key holder jig 204 and a stopper 1000 attached thereto for maintaining and providing a predetermined distance between collimator lens 206 and a camera module of test key 900.

FIG. 11 is an image showing test results 1100 displayed on the screen of a computer system 1102 coupled to tester 100. The target is such that the operator can look at the resolvable objects and determine an SFR score.

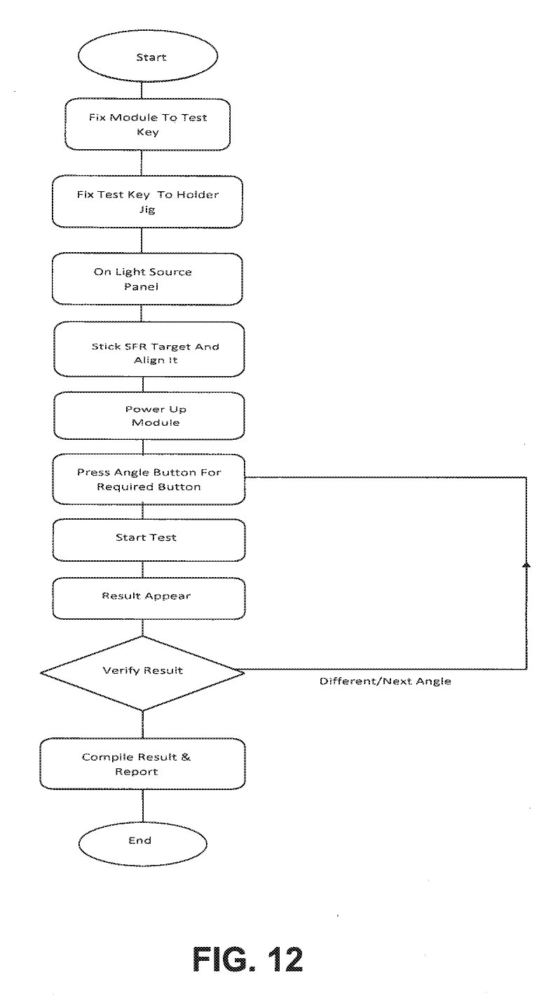

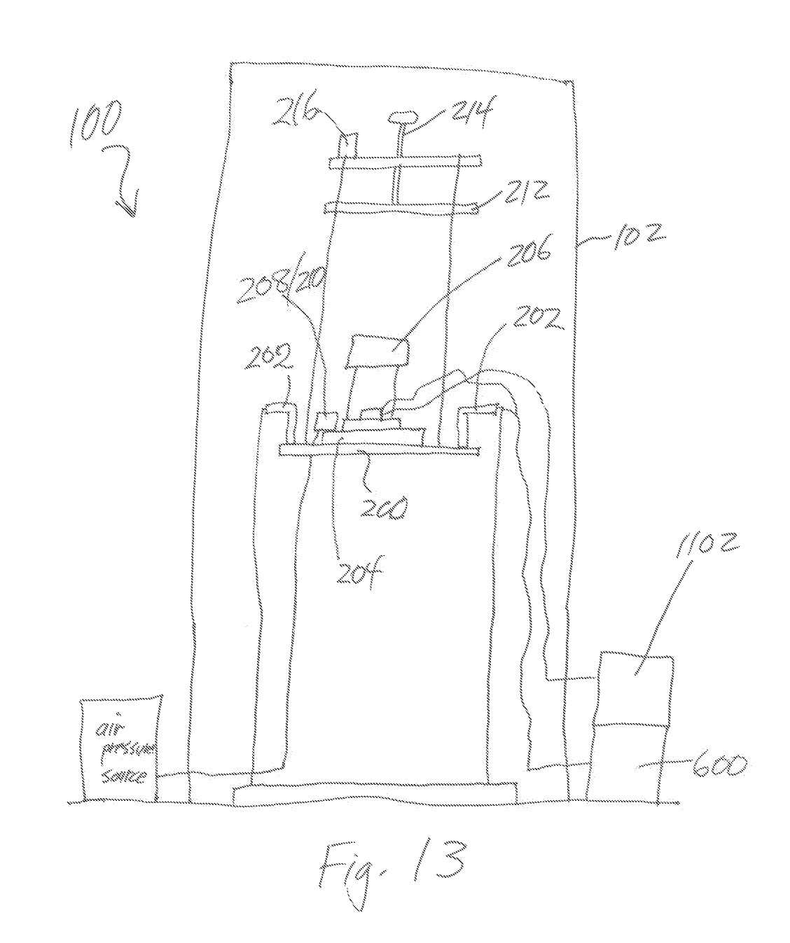

FIG. 12 shows a flowchart summarizing a process for operating tester 100. The flowchart is intended to be followed by an operator of tester 100 so as to ensure that the test results are all achieved with the desired testing method. The camera module is affixed to the test key. The test key is affixed to the holder jig. The light source panel is turned on. The SFR target is affixed to the light source panel and aligned. The camera module is powered up. The order of the previous steps is somewhat arbitrary as they could be changed and not depart from the disclosure herein. The operator selects the angle for the first measurement. The operator initiates the SFR measurement and the results are subsequently displayed to the operator, who may determine the SFR score and verify that the results are within the expected range. If they are not, the operator can check the system for issues. The operator then selects a different angle and repeats the test. This sequence is repeated until measurements have been made at each of the desired angles. A report may then be compiled.

FIG. 13 shows the interconnection of various components of the tester 100 shown in position to test a camera module under test 1302. While certain components have been shown as located inside or outside of the frame 102, this should not be considered limiting.

While phrases like “interconnected to” are used in this application, this may include both direct attachment between the two members as well as indirect attachment between the two members, such as when there are one or more intermediate members that form part of the interconnection. It may also be said that two members may “move in concert with one another” if they are rigidly connected together as well as if they are

The disclosed tester and test method provide several advantages over the prior art. First, they provide a consistent and repeatable manner for testing camera modules that allows for different units of the same camera modules to be compared against each other and for different models of camera modules to be compared against each other. Second it provides a technique for measuring image quality at different rotational orientations of a camera module. It also provides a relatively compact test system as well as one that maximizes operator safety. The multi -directional SFR measurement system also enhances product development activities associated with digital cameras. Further, the measurement system provides a means for analyzing a product's performance and/or design manufacturability so as to ensure a good product is developed for manufacturing. The system facilitates the identification of critical quality issues associated with a product's performance and/or design manufacturability so as to ensure that no/minimal immediate losses occur during the initial manufacturing of the product. Some multi-direction SFR measurements acquired by the system are also targeted to support future high end products with auto-focus/zoom mechanisms.

While the embodiments of the invention have been illustrated and described in detail in the drawings and foregoing description, such illustration and description are to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

We claim:

1. A system for testing a camera module under test, comprising:
a test stand;
a rotatable test fixture rotatably attached to the test stand, the test fixture accepting a camera module under test; and
a target to be imaged by the camera module under test, the target being interconnected to the test fixture.

2. A system as defined in claim 1, further including a collimating lens interconnected to the test fixture, the collimating lens receiving light from the target and refracting the light toward the camera module under test.

3. A system as defined in claim 2, wherein the system is operated by a user, wherein the position of the collimating lens relative to the test fixture is controlled by air pressure, and further including an air pressure controller interconnected to the test fixture and fluidly connected to the interconnection of the collimating lens to the test fixture.

4. A system as defined in claim 3, wherein the air pressure controller includes a fluid control actuator for the user to actuate to vary the air pressure.

5. A system as defined in claim 3, wherein the air pressure controller includes an air pressure gauge to provide an indication to the user of the air pressure.

6. A system as defined in claim 1, wherein the camera module under test is attached to a test jig which is attached to the test fixture, and wherein the collimating lens is also attached to the test jig.

7. A system as defined in claim 6, wherein the collimating lens further includes a stopper of a predetermined length that is used to provide a predetermined spacing between the lens and the camera module under test.

8. A system as defined in claim 7, wherein the system includes a controller associated therewith for controlling operation of the camera module under test.

9. A system as defined in claim 8, wherein the controller also controls an angle of rotation of the rotatable test fixture.

10. A system as defined in claim 1, wherein the target includes at least one resolvable object in a center portion thereof and at least one resolvable object in a peripheral region thereof.

11. A system as defined in claim 10, wherein the target is in the shape of a rectangle and the at least one resolvable object in the peripheral region include at least four resolvable objects, one in each of four corners of the rectangle.

12. A system as defined in claim 1, wherein the target is interconnected to the test fixture in a manner that allows for the distance between the target and the test fixture to be adjusted.

13. A system as defined in claim 1, wherein the target is directly attached to a light source panel that provides backlighting to the target.

14. A system as defined in claim 1, wherein the frame is in the shape of a box with lateral sidewalls and all of the lateral sidewalls include glass between members of the frame, so as to enclose the lateral sidewalls.

15. A system as defined in claim 1, wherein the system is operated by a user, and further including an angle indicator interconnected to the test fixture in a manner to maintain the same angular relationship between the angle indicator and the test fixture in order to provide an indication to the user of the angular position of the test fixture.

16. A method for testing a camera module under test, comprising:
affixing the camera module under test to a rotatable test fixture;
rotating the test fixture to a desired angle; and
capturing an image of a target with the camera module under test, the target being interconnected to the test fixture.

17. A method as defined in claim 16, further including image processing the captured image to determine the spatial frequency response of the camera module under test.

18. A method as defined in claim 17, wherein the image processing includes determining the spatial frequency response at various points in the captured image.

19. A method as defined in claim 16, wherein the rotating and capturing operations are repeated for a plurality of angles.

20. A method as defined in claim 16, further including providing a collimating lens interconnected to the test fixture, the lens being located between the target and the camera module under test.
